(19) United States
(12) Patent Application Publication
(10) Pub. No.: US 2016/0290274 A1
(43) Pub. Date: Oct. 6, 2016

(54) METHOD, COMPUTER PROGRAM, ELECTRONIC STORAGE MEDIUM AND ELECTRONIC CONTROL DEVICE FOR CONTROLLING AN INTERNAL COMBUSTION ENGINE

(71) Applicant: ROBERT BOSCH GMBH, Stuttgart (DE)

(72) Inventors: Hans-Juergen Hitz, Kornwestheim (DE); Herbert Schumacher, Gerlingen (DE); Thomas Middel, Renningen (DE)

(21) Appl. No.: 15/035,385

(22) PCT Filed: Sep. 25, 2014
(86) PCT No.: PCT/EP2014/070533

§ 371 Date: May 9, 2016

(30) Foreign Application Priority Data
Nov. 18, 2013 (DE) 10 2013 223 489.9

(51) Int. Cl. F02D 41/34; F02D 41/26

(52) U.S. Cl. CPC F02D 41/34; F02D 41/26

(57) ABSTRACT

A method, a computer program, an electronic storage medium, and an electronic control device for controlling an internal combustion engine are described, in which an injection is distributed among at least three partial injections. The spacing of the partial injections and/or the distribution of the injection quantities of the partial injections is predefined as a function of a parameter that characterizes the combustion sequence.

### FIELD

The present invention relates to a method, a computer program, an electronic storage medium, and an electronic control device for controlling an internal combustion engine.

### BACKGROUND INFORMATION

German Patent Application No. DE 100 40 117 describes a method and an apparatus for controlling an internal combustion engine. The injection operation therein is distributed among a pre-injection, a main injection, and a post-injection. The main injection is in turn divided into several partial injections.

In diesel internal combustion engines having a common rail system, the injection operation is usually made up of one to two pre-injections, a main injection, and optionally a closely successive post-injection. These injections are torque-forming. The combustion of the pre-injection quantities and of the main injection quantity determines the combustion noise. The closely successive post-injection is used for particulate oxidation and plays no part in combustion noise. An improvement in noise can be achieved by way of an optimized pre-injection or two pre-injections.

It has been recognized in accordance with the present invention that optimization of fuel consumption requires an early combustion location with conversion focal points shortly after the engine's top dead center point. If these combustion locations are combined with good nitrogen oxide and particulate emission, high injection pressures are required for good mixture preparation. Combustion noise is then at a very high level, however, due to a high combustion speed and little volume change in the cylinder. Conventionally, particulate emission and combustion noise are highly coupled by way of the injection pressure and thus the mixture preparation quality. An object that thus arises is that of decoupling the relationship between particulate emission and combustion noise.

### SUMMARY

A method, computer program, electronic storage medium, and electronic control device according to example embodiments of the present invention, may have the advantage that combustion noise can be decreased and emissions and fuel consumption can likewise be reduced.

Because the spacing of the partial injections and/or the distribution of the injection quantities of the partial injections is predefined as a function of a parameter that characterizes the combustion sequence, improvements can be achieved in the conflicting objectives of combustion noise, emissions, and fuel consumption.

It is particularly advantageous if the parameter follows a predefined profile. Preferably the spacing of the partial injections and/or the distribution of the injection quantities is predefined so that the parameter does not decrease to zero in a specific angle range.

It is furthermore advantageous if the spacing of the partial injections and/or the distribution of the injection quantities is predefined so that the parameter exhibits an almost constant profile in a specific angle range. This means that the derivative of the parameter over time or over the angular position of the crankshaft is less than a threshold value.

The change in combustion chamber pressure as a function of the angular position of the crankshaft is preferably considered as a parameter. This combustion variable is also referred to hereinafter as a “pressure change” or “pressure change as a function of crankshaft angle.”

Alternatively, the combustion rate can also be considered as a combustion variable. The combustion rate describes how much fuel is combusted, and converted into heat, per degree of crankshaft angle. As the combustion rate rises, the pressure change also becomes greater.

Alternatively to these variables, variables that are closely correlated with these variables can also be used as a parameter. Instead of the combustion rate, for example, it is also possible to use a variable that indicates the thermal change as a function of crankshaft angle change.

In accordance with the present invention, a change in, or the derivative of, one of the variables as a function of crankshaft angle is used as a parameter.

In a simple embodiment, the cylinder pressure is measured directly by way of a sensor in the combustion chamber. In an alternative embodiment provision can also be made that the cylinder pressure, which can also be referred to as “combustion chamber pressure,” can be calculated proceeding from other measured variables, for example the engine speed.

The change in combustion chamber pressure, or another criterion, can thereby be constituted. Alternatively or additionally, the combustion rate is predefined in such a way that it does not decrease to zero in a specific angle range.

With these actions, good mixture preparation and thus low exhaust emissions and low consumption are achieved simultaneously.

It is particularly advantageous if the distribution of the injection quantities of the partial injections and/or the spacing of the partial injections is correspondingly predefined in the context of the application.

It is particularly advantageous if these variables are established in the context of a closed-loop control system.

The present invention is explained below with reference to the figures.

### BRIEF DESCRIPTION OF THE DRAWINGS

FIG. 1 schematically depicts an apparatus for controlling an internal combustion engine.

FIG. 2 is a diagram in which various signals are plotted against time.

FIG. 3 is a flow chart to explain an example embodiment of the method according to the present invention.

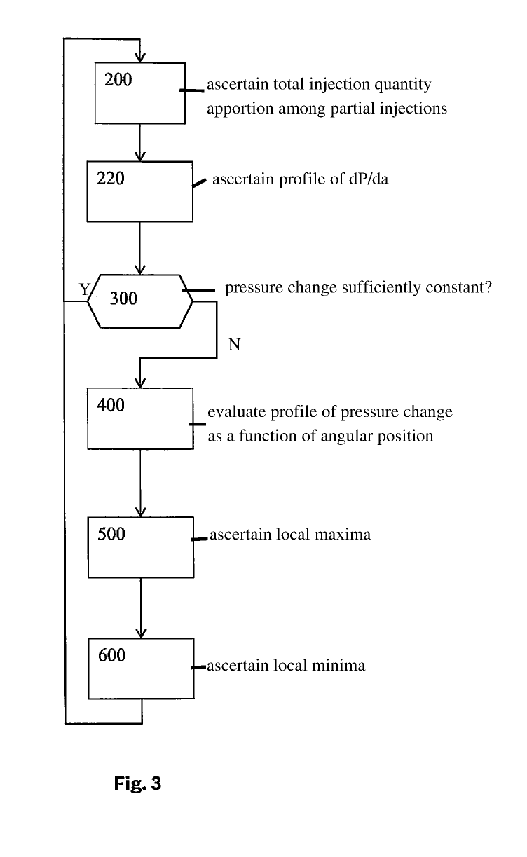

### DETAILED DESCRIPTION OF EXAMPLE EMBODIMENTS

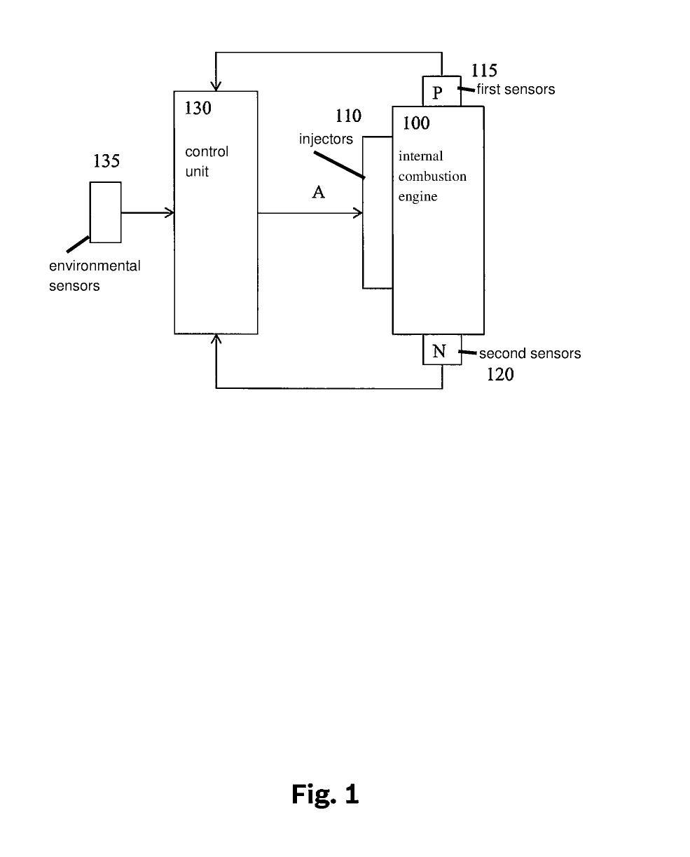

FIG. 1 schematically depicts various elements of an apparatus for controlling an internal combustion engine. The internal combustion engine is labeled 100. Fuel is supplied to internal combustion engine 100 via injectors 110 as a function of a control application signal A. Disposed on the internal combustion engine is a first sensor 115 that delivers a signal indicating the combustion chamber pressure P. Also provided are second sensors 120 that furnish various signals which characterize the operating state of the internal combustion engine. Provision can be made here, for example, that a signal N regarding the rotation speed of the internal combustion engine is delivered. Output signals of first sensor 115 and of second sensor 120 travel to a control unit 130. The control unit furthermore processes the output signals of environmental sensors 135. As a function of the input signals, control unit 130 calculates the control application signal A for application of control to injectors 110.

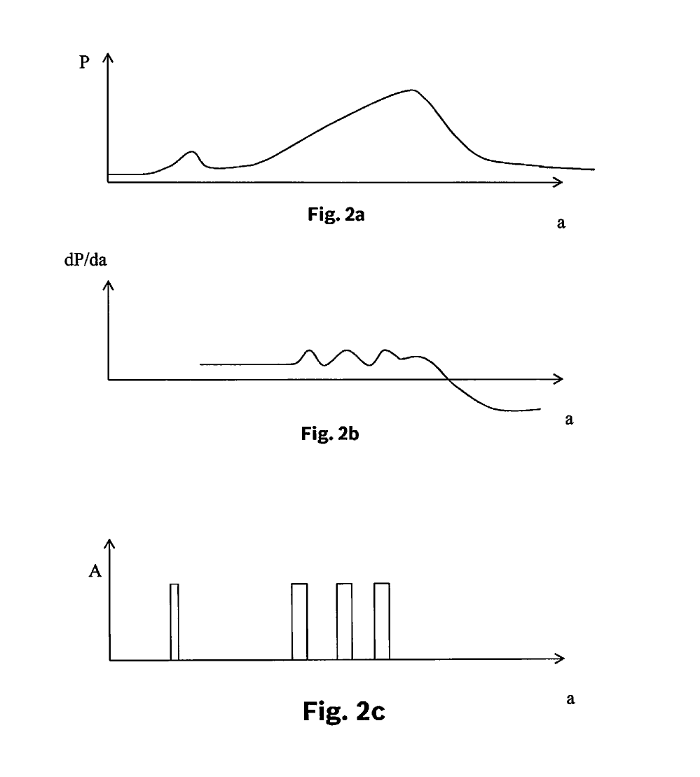

In FIG. 2a, heat release W is plotted against the crankshaft angle. In portion 2b of the Figure, the derivative dP/da of combustion chamber pressure P over the crankshaft angle is plotted against the crankshaft angle. This variable is referred to hereinafter as the “pressure change.” In portion 2c of the Figure, the control application signal A for impingement upon the injectors is plotted against the crankshaft angle.

FIG. 2 depicts a control application situation that is not yet optimized. The control application pulses of the noise-determining partial injections are plotted in portion 2c of the Figure. Control application V1 is the pre-injection that is usual in the existing art. Its consequence is a small rise in heat release W immediately after the pre-injection. The three partial injections depicted, which correspond to the main injection in the context of the existing art, likewise result in a rise in heat release W. The contributions of the individual partial injections T1, T2, and T3 are evident in the heat release signal W and in the pressure change dP/da. Each partial injection can have a rise or a local maximum associated with it. The local maxima that are associated with the partial injections are separated by local minima.

A distinction will be made below between pre-injections, post-injections, and a main injection distributed among several partial injections. In the embodiment depicted, the main injection is distributed among three partial injections. Provision can also be made according to the present invention that the main injection is distributed among two, or a greater number of, partial injections.

In an embodiment, provision can also be made that the procedure according to the present invention is applied to the noise-determining partial injections and/or to the torque-forming partial injections. This means that a distinction is no longer made between pre-injection and main injection. Instead the pre-injection and the main injection in the context of the existing art are distributed among at least three partial injections, the spacing of the partial injections and/or the distribution of the injection quantities being ascertained in accordance with the procedure according to the present invention.

What is recognized according to the present invention is that low-noise combustion, with low fuel consumption and low exhaust emissions, results if the pressure change dP/da as a function of crankshaft angle is almost constant in the region of the noise-determining injections, and in particular during the partial injections that correspond to the main injection and/or the pre-injection in the existing art. It is furthermore recognized according to the present invention that the profile of the pressure change can be influenced by adjusting the spacings of the partial injections and/or by adjusting the distribution of the quantities of the partial injections.

It is furthermore recognized that low-noise combustion with low fuel consumption and low exhaust emissions results when the combustion rate as a function of the crankshaft angle does not drop back to zero in the region of the noise-determining injections, and in particular between two partial injections that correspond to the main injection in the existing art. It is furthermore recognized according to the present invention that the profile of the combustion rate can be influenced by adjusting the spacings of the partial injections and/or by adjusting the distribution of the quantities of the partial injections.

The magnitude of the pressure change of the local maxima associated with the partial injection can thus be reduced by reducing the injection quantity or by reducing the control application duration of a partial injection. The depth of the local minimum of the pressure change can be reduced by decreasing the spacing of the partial injections.

According to the present invention, by way of these actions the spacing of the partial injections and the distribution of the fuel quantity of the individual partial injections are ascertained so as to result in a maximally constant profile for the pressure change. This means that the duration of the partial injections and the spacing of the partial injections are predefined as a function of the ripple of the change in the combustion chamber pressure as a function of crankshaft angle. The “distribution of the fuel quantities” refers to the proportion of the individual partial injections in terms of the total quantity. This proportion is usually indicated as a percentage and is stored in a memory or a characteristics map. The “total quantity” refers to that fuel quantity which, aside from the pre-injections and the successive post-injection, makes a contribution to the torque furnished by the internal combustion engine.

A particularly advantageous adaptation method for ascertaining the distribution of the injection quantities of the partial injections, and the spacings of the partial injections, is described below.

In a first step 200, proceeding from environmental variables and operational parameters, the total injection quantity is ascertained and is apportioned among a predefined number of partial injections. Using these injection quantities, thereby ascertained, for the partial injections, and the spacings for the partial injections, the control application signal A for impingement upon injections 110 is calculated. Control is applied to injectors 110 with this control application signal.

In a subsequent second step 220, the profile of the pressure change dP/da as a function of angular position is ascertained. If a combustion chamber pressure sensor is present for each cylinder, its output signal is used to calculate the pressure change. If a corresponding sensor is not available, a substitute signal for the pressure change can be used. Provision can also be made that the combustion chamber pressure, the pressure change, or the substitute signal are calculated on the basis of other easily measurable variables, for example the engine speed.

In the subsequent third step 300 a check is made as to whether the pressure change is sufficiently constant. If not, the fourth step 400 then follows. This means that a check is made as to whether the pressure change follows a predefined target profile.

If the pressure change is sufficiently constant, the distribution of the partial injections and the spacings of the partial injections are used in the first step 200 for the further determination of the injection quantities and the spacings of the partial injections.

In the fourth step 400 the profile of the pressure change as a function of angular position is evaluated. For example, the local maxima and local minima are ascertained and are associated with the individual partial injections. The spacings of the local maxima are also ascertained.

In a fifth step 500 the local maxima at which the pressure change possesses the greatest value is ascertained. The injection quantity of the partial injection associated with this maxima is reduced by a specific amount. The injection quantity of the other partial injections is increased by the corresponding amount in such a way that the total injection quantity remains unchanged. In a particularly advantageous embodiment provision can be made that this injection quantity is apportioned as a function of the magnitude and crank angle position of the other local maxima.

In a sixth step 600 the local minima are ascertained. Each local minimum is associated with two partial injections. One of the two associated partial injections is located before, and the other after, the local minimum. For the local minimum at which the pressure change possesses the lowest value, the spacing of the two partial injections that are associated with that minimum is decreased.

With these injection quantities, thereby ascertained, for the partial injections, and the spacings for the partial injections, the control application signal A for impingement upon injections 110 is calculated. Control is applied to injectors 110 with this control application signal. The second step then follows.

In an embodiment, provision can also be made that the duration of the partial injections and the spacing of the partial injections is predefined as a function of the deviation of the pressure change from an average value of the pressure change. In this case an average value of the pressure change over a specific angle range is ascertained. The respective difference from that average value is then determined. If the pressure change is greater than the average value, the duration of the corresponding partial injection is then reduced. If the pressure change is less than the average value, the spacing of the corresponding partial injections is then decreased. This embodiment is advantageous in that fewer iteration steps are needed until an optimum combustion takes place.

According to the present invention the above-described method can be carried out during application of the internal combustion engine on a test stand. In this case the distribution of the partial injections and the spacings of the partial injections are ascertained using the above method and stored, as a function of environmental conditions and operational parameters of the internal combustion engine, in a memory, in particular as a characteristics diagram. During normal operation of the internal combustion engine, these variables are read out from the memory and utilized to calculate the injection quantities and the spacings of the partial injections. This embodiment is advantageous in that a sensor for ascertaining the combustion chamber pressure is not required during normal operation of the internal combustion engine. It is disadvantageous that the variables must be ascertained in dependent fashion for a plurality of variables that characterize the operating state and/or environmental conditions, and stored in a memory. The outlay for ascertainment on the test stand, and for memory space, rises sharply with the number of variables taken into consideration; the accuracy of the method improves with greater numbers of variables taken into consideration.

In a preferred embodiment the method described is used in the context of a closed-loop control system. It is necessary here for corresponding sensors, for example for sensing the combustion chamber pressure, to be present. During normal operation of the internal combustion engine, the distribution of the partial injections and the spacings of the partial injections are ascertained as described above, and are used in the context of subsequent injections.

It may be disadvantageous in this context if the sensor complexity is greater. In addition, the values should be re-learned ab initio with each change in the operating states and/or environmental conditions.

In a further preferred embodiment, provision is made that the method is embodied to adapt stored values for the distribution and the spacings. With this embodiment the distribution and spacings of the partial injections are ascertained as a function of a few operating states and environmental conditions in the context of application or upon initial setup. In normal operation the values for distribution and for the spacings are ascertained with the above method and used in the context of subsequent injections. If the respectively ascertained values deviate from the stored values, the stored values are then overwritten with the values just ascertained. This is a closed-loop control system having a pilot control system based on learned values.

This embodiment has the advantage that the outlay in the context of application is appreciably reduced. The elapsed time until the values are re-learned in the context of a change in conditions is appreciably shortened by this procedure. This is the case in particular when the values are stored as a function of variables that, generally, change quickly.

1-9. (canceled)

10. A method for controlling an internal combustion engine, the method comprising:
distributing an injection among at least three partial injections, wherein at least one of: a spacing of the partial injections, and a distribution of injection quantities of the partial injections, is predefined as a function of a parameter that characterizes a combustion sequence.

11. The method as recited in claim 10, wherein the parameter follows a predefined target profile.

12. The method as recited in claim 11, wherein at least one of: the duration of the partial injections, the spacing of the partial injections, and a number of partial injections, are predefined as a function of a deviation from the target profile.

13. The method as recited in claim 10, wherein a pressure change or a combustion rate is used as a parameter.

14. The method as recited in claim 10, wherein the parameter is ascertained based on a combustion chamber pressure variable.

15. The method as recited in claim 14, wherein the combustion chamber pressure variable is sensed by way of a combustion chamber pressure sensor.

16. An electronic storage medium storing a computer program for controlling an internal combustion engine, the computer program, when executed by a control unit, causing the control unit to perform:
distributing an injection among at least three partial injections, wherein at least one of: a spacing of the partial injections, and a distribution of injection quantities of the partial injections, is predefined as a function of a parameter that characterizes a combustion sequence.

17. An electronic control device designed to control an internal combustion engine by distributing an injection among at least three partial injections, wherein at least one of: a spacing of the partial injections, and a distribution of injection quantities of the partial injections, is predefined as a function of a parameter that characterizes a combustion sequence.
